(19) United States
(12) Patent Application Publication
(10) Pub. No.: US 2013/0242918 A1
(43) Pub. Date: Sep. 19, 2013

(54) METHOD FOR PROVIDING A LOCAL TRAFFIC SHORTCUT IN A PACKET-ORIENTED MOBILE COMMUNICATION NETWORK

(71) Applicant: HUAWEI TECHNOLOGIES CO., LTD., Shenzhen (CN)

(72) Inventors: Qing ZHOU, Berlin (DE); Frank SCHRAMM, Berlin (DE); Mirko SCHRAMM, Berlin (DE); Konstantinos PENTIKOUSIS, Berlin (DE)

(73) Assignee: Huawei Technologies Co., Ltd., Shenzhen (CN)

(21) Appl. No.: 13/875,876

(22) Filed: May 2, 2013

Related U.S. Application Data
(63) Continuation of application No. PCT/CN2010/078444, filed on Nov. 5, 2010.

(51) Int. Cl. H04W 72/04

(52) U.S. Cl. CPC H04W 72/04
USPC 370/329

(57) ABSTRACT

A method for providing a local traffic shortcut (LTS) in a packet-oriented mobile communication network comprising the steps of storing in a LTS-database the IP addresses of all devices served by at least one network node of said network along with a node-ID of the respective network node; receiving an IP data packet by a network node and extracting a destination IP-address from the received data packet; querying the LTS-database with the extracted destination IP-address of the received data packet to identify at least one network node for performing a local traffic shortcut (LTS); and establishing an LTS path with the identified network node.

### CROSS-REFERENCE TO RELATED APPLICATIONS

This application is a continuation of International Patent Application No. PCT/CN2010/078444, filed on Nov. 5, 2010, which is hereby incorporated by reference in its entirety.

### TECHNICAL BACKGROUND

The invention relates to a method for providing a local traffic shortcut in a packet-oriented mobile communication network and in particular in a 3GPP network.

Mobile communication networks are applying a specific mechanism to provide mobility for end devices such as a user equipment (UE). This mechanism ensures that IP packets can be transferred between the respective end device and an edge gateway in the mobile communication network where an IP address of the end device is maintained. Accordingly, a mobility mechanism is tunnelling the IP packets through the infrastructure of the mobile communication network along a path consisting of a radio access node and one or more gateways.

One of the characteristics of mobile communication networks is that a certain amount of data traffic is exchanged between end devices that are locally close to each other, for example persons in the same street, town or city area. In contrast, the location of the edge gateway of the mobile communication network is, however, typically in a certain distance from the radio access node. Depending on the expected overall amount of data traffic an edge gateway can be responsible for a large area (like a whole city) but also for a whole country. Consequently, in conventional mobile communication networks data traffic exchanged between two end devices may run through a very large area (such as a whole country) even if the two end devices are connected to the very same radio access node.

Consequently, data traffic is unnecessarily transferred throughout the conventional mobile communication network thus wasting resources, processing capacity and energy. Accordingly, it is a goal of the present invention to provide a method which uses efficiently a transport capacity provided by a mobile communication network.

### SUMMARY OF THE INVENTION

According to a first aspect of the present invention a method for providing a local traffic shortcut (LTS) in a packet oriented mobile communication network is provided, wherein the method comprises the steps of:

(a) storing in a local traffic shortcut control point (LTSCP) IP addresses of devices served by at least one network node of said network along with a node-ID of the respective network node;

(b) receiving an IP data packet by a network node from a served device and extracting a destination IP-address from the received data packet;

(c) querying the local traffic shortcut control point (LTSCP) by said network node with the extracted destination IP-address of the received data packet to identify at least one network node for performing an LTS;

(d) establishing an LTS path with the identified network node; and

(e) routing IP data packets having said destination IP address through the established LTS path.

According to a possible implementation of the first aspect of the present invention a LTS permission indicating whether an establishment of a LTS path is admissible for the respective served device is provided to the network node when the served device connects to the network node and stored in the network node, wherein the network node interacts with the LTSCP only if the LTS permission is provided.

According to a possible implementation of the first aspect of the present invention the served device is formed by a UE.

According to a possible implementation of the first aspect of the present invention the destination IP-address of an IP-data flow is extracted from a header of a first IP-data packet of said IP data flow to query the LTSCP for the existence and identity of a network node to establish an LTS path.

In a possible implementation of the first aspect of the present invention the querying network node receives the identity of the network node for performing LTS only if this complies with configuration data of said LTSCP.

In a possible implementation of the first aspect of the present invention the packet oriented mobile communication network is formed by a hierarchical network having different hierarchy levels.

In a possible implementation the LTS path is established between network nodes of the same hierarchy level.

According to a possible implementation of the first aspect of the present invention if a direct connection between a network node and another network node is available, the LTS path is established at the lowest possible hierarchy level of the network.

In a possible implementation of the first aspect of the present invention a LTS-database is provided at the LTSCP which receives the extracted destination IP-address of the received IP data packet from the network node for performing the query in the LTS-database.

In a possible implementation of the first aspect of the present invention the network node serving the user equipment devices is formed by a traffic shortcut point (TSP).

In a possible implementation of the first aspect of the present invention the traffic shortcut point is formed by a base station.

In a further possible implementation of the method according to the present invention the traffic shortcut point is formed by a serving gateway.

In a still further possible implementation of the first aspect of the present invention the traffic shortcut point is formed by an enhanced packet data gateway (ePDG) of the network.

In a still further possible implementation of the first aspect of the present invention the served UE is formed by a mobile device which is connected with a base station via a wireless link.

In a possible implementation of the first aspect of the present invention the established LTS path is stored in a local memory of the serving network node having received the IP data packet from the served device and removed if no IP data packets are transferred along the LTS path for a configurable duration.

In a possible implementation of the first aspect of the present invention the established LTS path stored in the local memory of the serving network node is updated when a handover of the served device to another base station is performed.

According to a second aspect of the present invention a packet-oriented network communication network is provided comprising:

a LTSCP performing a query in a LTS-database on the basis of an extracted destination IP-address of a data packet received by a first network node from a served device to identify at least one second network node for establishment of an LTS path between the first network node and the identified second network node.

wherein the LTS-database of the LTSCP stores the IP-addresses of UEs served by at least one network node of said network along with a node-ID of the respective serving network node.

According to a possible implementation of the packet-oriented network communication network according to the second aspect of the present invention the serving network node is formed by a TSP. This traffic shortcut point can be formed in a possible implementation by a base station.

Furthermore, the TSP can be formed by a serving gateway SGW of the network.

In a still further possible implementation the traffic shortcut point can be formed by an ePDG of the network.

In a possible implementation of the packet-oriented network communication network according to the second aspect of the present invention the served device is a UE which can be formed by a mobile device connected to a base station via a wireless link.

According to a possible implementation of the packet-oriented network communication network according to the second aspect of the present invention the packet-oriented mobile communication network can be formed by a hierarchical network having different hierarchy levels wherein the LTS path may be established in a possible embodiment between network nodes of the same hierarchy level.

In a possible implementation of the packet-oriented network communication network according to the second aspect of the present invention the packet-oriented mobile communication network can comprise a 3GPP network or a WIMAX network.

### BRIEF DESCRIPTION OF THE FIGURES

FIG. 1 shows a flow chart of a possible implementation of a method for providing an LTS in a packet-oriented mobile communication network according to a first aspect of the present invention;

FIG. 2 shows a block diagram of a reference architecture of a packet-oriented mobile communication network according to a second aspect of the present invention wherein a method for providing an LTS can be employed;

FIG. 3 shows an exemplary signal diagram for an example procedure as an exemplary implementation of a method for providing an LTS according to the first aspect of the present invention;

FIG. 4 shows a diagram for illustrating an IP packet forwarding between traffic shortcut points located in the same network element;

FIG. 5 shows a diagram for illustrating forwarding of an IP packet when traffic shortcut points are located in different network elements; and

FIGS. 6 and 7 show diagrams for illustrating handover procedures performed by possible implementations of a method according to a further aspect of the present invention.

### DETAILED DESCRIPTION OF EMBODIMENTS

In the following possible implementations of different aspects of the present invention are described with reference to the enclosed figures.

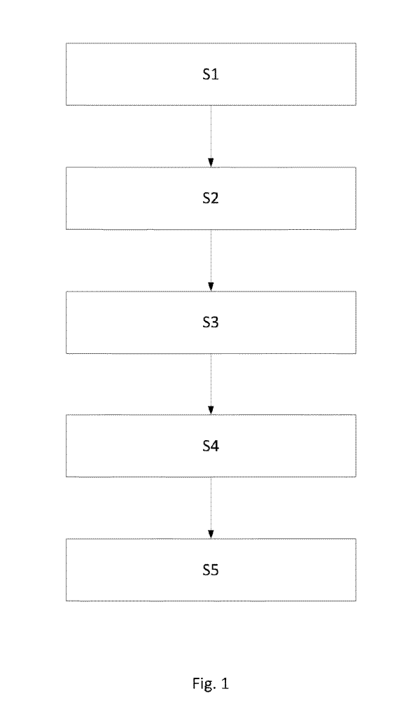

As can be seen in FIG. 1 showing a possible exemplary implementation of a method for providing an LTS in a packet-oriented mobile communication network the method can comprise several steps S1-S4.

In a first step S1 IP-addresses of devices such as UEs served by at least one network node of the network are stored in a local traffic shortcut control point (LTSCP) having a LTS-database along with a node-ID of the respective network node. The node-ID can be formed by an IP-address of the respective network node. The served device can be formed by a network element in particular a user equipment device. Further, it is possible that the served device comprises another network node element of the network such as a server.

In a further step S2 an IP data packet is received by a network node from a served UE and a destination IP-address is extracted from the received data packet.

In a further step S3 the LTS-CP is queried by the network node with the extracted destination IP-address of the received data packet to identify the existence and identity of a network node for performing an LTS.

In a step S4 an LTS path is established with the identified network node. The identified network node can be the querying network itself or another network node of the packet-oriented mobile communication network.

In step S5 IP data packets having the extracted destination IP address are routed through the established LTS path.

The mechanism provided by a method for providing a local traffic shortcut LTS in a packet-oriented mobile communication network according to a first aspect of the present invention is primarily based on an IP-address of an end device such as a terminal or a UE in a local area wherein the IP-address is stored together with addresses of network entities or network nodes serving the respective end device or UE. Upon receiving an IP data packet it is checked by the respective receiving network node whether the data traffic received is a local data traffic or a non-local data traffic. This can be done based on a destination IP-address of the IP data packet and the IP-address is stored in step S1. If the received data traffic is a local data traffic in a possible implementation a LTS data path for the special data traffic is setup in step S4. For the local traffic the IP data packet is then routed via the established LTS data path.

In a possible implementation in step S1 it is further checked whether the establishment of a local traffic shortcut LTS is allowed or not. This check can be performed in a possible embodiment based on an LTS policy received in advance. If the establishment of a LTS path is allowed the IP-address of the end device or UE is stored in step S1. The IP-address of the UE can be stored together with identity information of the entity or network node serving the respective UE or end device. This allows that the data traffic of other end devices or UE can be checked against the stored information data. In contrast, if establishment of a local traffic shortcut LTS is not allowed the IP-address of the end device UE is not stored in a possible implementation. In a still further implementation of the first aspect of the present invention the storage of IP-address of the network entities serving the UE are updated when the user equipment device UE or mobile terminal moves. In a possible implementation it is checked whether LTS is allowed or not for the bearer tunnel where the IP packet is received based on a LTS policy received in advance. In a further possible implementation for data traffic with the same destination IP-address checking of local traffic can be performed only on the basis of the first IP packet of the respective packet flow. In this possible implementation for the subsequent IP data packets of the packet flow the established LTS path can be used. In a still further implementation the established LTS path is kept or maintained for a configurable period of time. If the configurable duration expires and no IP packet has been received within the configurable time duration the IP path can be cancelled in a possible embodiment.

As described the method according to the exemplary implementation shown in FIG. 1 can be employed in a packet-oriented mobile communication network, and in particular in a 3GPP network or a WIMAX network. This packet-oriented communication network can comprise at least one LTS-database for storing the IP-addresses of UE served by at least one network node of the network along with a node-ID of the respective serving network node. Further, the packet-oriented communication network can comprise in a possible implementation a local traffic shortcut control point LTS CP performing a query in the LTS-database on the basis of an extracted destination IP-address of a data packet (DP) received by a first network node from a UE to identify at least one second network node for establishment of an LTS path between the first network node and the identified second network node. The first and second network node can be different network nodes of the network but can also be formed by the same querying network node.

In the packet-oriented network communication network according to the second aspect of the present invention the serving network node can be formed by an TSP comprising a base station, a serving gateway or e.g. an enhanced packet data gateway of the network. The packet-oriented mobile communication network according to the second aspect of the present invention can be formed by a hierarchical network having different hierarchy levels wherein the LTS path is established in a possible embodiment between network nodes of the same hierarchy level. In a possible implementation if a direct connection between a network node and another network node is available the LTS path can be established in a possible embodiment at the lowest possible hierarchy level of the network.

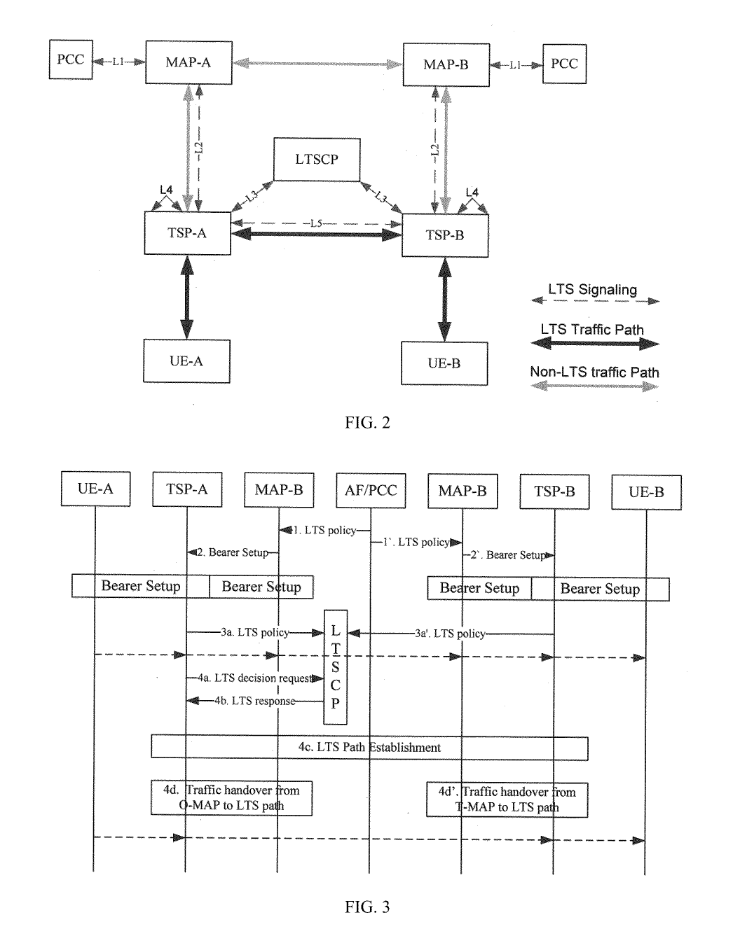

Further exemplary embodiments and implementations are described in the following with reference to a basic reference architecture of a packet-oriented network communication network which can employ a method providing an LTS according to the first aspect of the present invention. The network can comprise different functional elements located in the same or different network nodes, in particular the equipment devices, UE or mobile terminals connected via wireless links to the TSPs which can be formed by radio access networks, in particular base stations BS. Further, the communication network can comprise mobile anchor points (MAPs) and at least one LTSCP gathering data and information for LTS decision and establishing of LTS paths. In a possible implementation the packet-oriented communication network according to the second aspect of the present invention comprises according to the reference architecture shown in FIG. 2 the following elements:

UE: There are two UEs in the reference architecture, UE-A and UE-B. LTS does not have an impact to UE: its functionality remains as defined in EPS.

MAP: Mobile Anchor Point, e.g. PGW, which serves the corresponding UE. It is included in a non-LTS path, but not included in the LTS path. It could be separated to the Originating MAP (O-MAP), which serves the UE sending the IP packet, and the Target MAP (T-MAP), which serves the UE receiving the IP packet.

TSP: Traffic Shortcut Point, i.e. the user plane node which can shortcut the data traffic. It can include O-TSP and T-TSP functions. There can be several TSPs in the user plane for each of the UEs.

O-TSP: Originating Traffic Shortcut Point, i.e. the user plane node which routes the IP packet from UE-A to the LTS path and bypasses the MAPs. Examples of O-TSP are eNodeB, SGW, ePDG which serve the UE sending the IP packet;

T-TSP: Terminating Traffic Shortcut Point, i.e. the user plane node which receives the IP packet from the LTS path and forwards it to the UE-B. Example of a T-TSP are eNodeB, SGW, ePDG which serve the UE receiving the IP packet;

LTSCP: the Local Traffic Shortcut Control Point gathers the information for LTS decision making. LTSCP is involved to the LTS decision making together with TSPs. The LTSCP can serve a certain LTS area (e.g. one country) inside an operator, to ensure that the same LTSCP is selected for all the terminals or UEs in the LTS area. Furthermore, the LTS areas served by different LTSCPs can be overlapped in the edge of the LTS area. If a UE is located in the overlapping area of the multiple LTS areas, all LTSCPs serving the overlapping areas are informed. The LTSCP can be an MME in a 3GPP network, which serves the 3GPP access only. Alternatively, the LTSCP can be collocated in a TSP, e.g. eNodeB or it can also be an additional network function.

All above functional elements of the LTS basic reference architecture can be implemented as logical functions. For example, O-MAP and T-MAP can be co-located in one PGW if the PGW is selected for both UE-A and UE-B, or O-TSP and T-TSP can be co-located in the same eNodeB/SGW/ePDG.

Furthermore, the architecture for LTS can include a PCC which provides the QoS and Charging policy for the traffic flows and may also provide the LTS policy (e.g. whether LTS is allowed or not).

First in a UE-A setup of a PDN connection to the network a default bearer or tunnel is created for the internet traffic. PCC sends the default TFT with the charging and QoS rules to TSP and MAP served UE-A. For example a TFT (src IP, src port, dst IP, dst port, proto) can be:

Traffic flow 1: source IP: (10.11.1.9. *, *, *, *);

Traffic flow 2: destination IP: (*, *, 10.11.1.9, *, *), where * is indicating any value.

UE-B performs also a setup of the PDN connection to the network and a default bearer is created for the internet traffic. PCC can send the default TFT with the charging and QoS rules to TSP and MAP served UE-B. For example the TFT can be:

Traffic flow 1: source IP: 10.11.2.31;

Traffic flow 2: destination IP: 10.11.2.31.

In LTS, besides the charging and QoS policy, the LTS policy can also be sent to the TSP and MAP on both UE-A and UE-B sides. The LTS policy can indicate whether the traffic in the default bearer is LTS allowed or not. The LTS policy can be built in PCC, based on the subscription profile, or charging policy (e.g. for offline charging only) or any other information. The LTS policy can also be built in TSP, MAP (e.g. PDN GW) based on the pre-configuration information (e.g. LI policy).

Upon receiving the PCC policy from the PCC, a bearer binding can be performed on both UE-A and UE-B sides, and a bearer setup request can be sent to the access. Currently in EPS, traffic with the same PCC rules (charging and QoS) can be bound to the same bearer.

In LTS, the bearer is bound to TFTs with the same LTS policy, i.e. LTS is allowed or not.

After bearer binding, if there is no existing bearer that can be used, further bearers can be established. The bearers between UE and TSP, and the bearer between TSP and MAP can be established in both UE-A and UE-B sides.

In LTS, it is checked whether LTS is allowed or not based on the LTS policy received. If LTS is allowed, the IP address of the end device UE can be stored together with identity information of the entity serving the end device UE. Otherwise, if LTS is not allowed, the IP address of the end device UE is not stored.

For example, if the bearer is LTS allowed, the TSPs can report its LTS policy to the LTSCP, which can maintain the database which includes the UE IP address and TSP list, e.g., for UE-A and UE-B, LTSCP can maintain the following information:

| UE IP address | TSP |
|---|---|
| 10.11.1.9 | TSP-A List |
| 10.11.2.31 | TSP-B List |

The LTSCP can also maintain additional information (e.g. IP port, protocol type) for performing a LTS decision. The additional information is reported by TSP based on the LTS policy received, e.g. LTSCP can maintain the following information:

| UE IP address | Destination IP port | Protocol type | TSP |
|---|---|---|---|
| 10.11.1.9 | All | All | TSP-A List |
| 10.11.2.31 | 2000~4000 | All | TSP-B List |
| 10.11.3.201 | 5000~6000 | TCP | TSP-C List |
| 10.11.4.88 | 21 | UDP | TSP-D List |

The database maintained in LTSCP can be updated in a possible implementation upon:

UE registration or de-registration, or
UE IP address updating, or
LTS policy updating, or
TSP updating when the terminal moves.

Upon receiving an IP data packet from UE-A, in the current network, the data traffic can be routed to MAP-A by TSP-A. In this example, the data traffic between UE-A and UE-B can be internet traffic, e.g. a P2P download, FTP file exchange or a social network service.

It can be checked whether LTS is allowed in the bearer, and if the data traffic received is local traffic or not based on the source and destination IP address in the IP packet. If so, a local bearer (LTS path) for the special traffic can be setup between TSP-A and T-TSP-B. Before the setup of the LTS path, the IP data packet received from TSP-A can also be routed to the MAP-A to avoid a transmission delay caused by the local traffic decision.

Following are additional steps performed to establish a LTS path as shown in FIG. 3:

TSP-A sends a LTS decision request in step 4a to LTSCP with source IP address and destination IP address of the IP packet.

The LTSCP can perform the LTS decision as follows:
i) LTSCP retrieves a list of O-TSPs based the LTS decision requests received from TSP-A.
ii) LTSCP retrieves a list of T-TSPs by searching the destination IP address of the traffic in the database.
iii) Based on the network topology information in the area, the possible O-TSP and T-TSP for the traffic can be selected.

The LTSCP sends in step 4b a LTS response to TSP-A. The LTS response can include the following options:
i) Non LTS, the LTS is not performed for the traffic, or is performed by another TSP.
ii) LTS indication, LTS can be performed for the data traffic. It may include the following additional information:
   T-TSP ID: the TSP which receives the IP packet;
   TFTs: the traffics can be LTS to the T-TSP.
   QoS policy: if the QoS in UE-A and UE-B is different as the QoS policies are applied for different bearers, the minimum one can be selected by the LTSCP. If MBR is used for the bearer for UE-A and UE-B, it is possible that the MBR in MAP-A and MAP-B are reduced.

Upon receiving the LTS indication from the LTSCP, the O-TSP can respond to initialize the local bearer with the target TSP, based on the request parameters from LTSCP. The local bearer can be a single direction, or a bi-direction bearer which is bound to the existing bearer between O-TSP and T-TSP. In a 3GPP SAE network architecture, the following LTS paths can be established in step 4c as shown in FIG. 3:

a LTS path in eNodeB, or

a LTS path between eNodeBs, or

a LTS path in AGW (SGW, ePDG), or

a LTS path between AGWs.

When the LTS path is established, the local bearer can be used for IP packet forwarding.

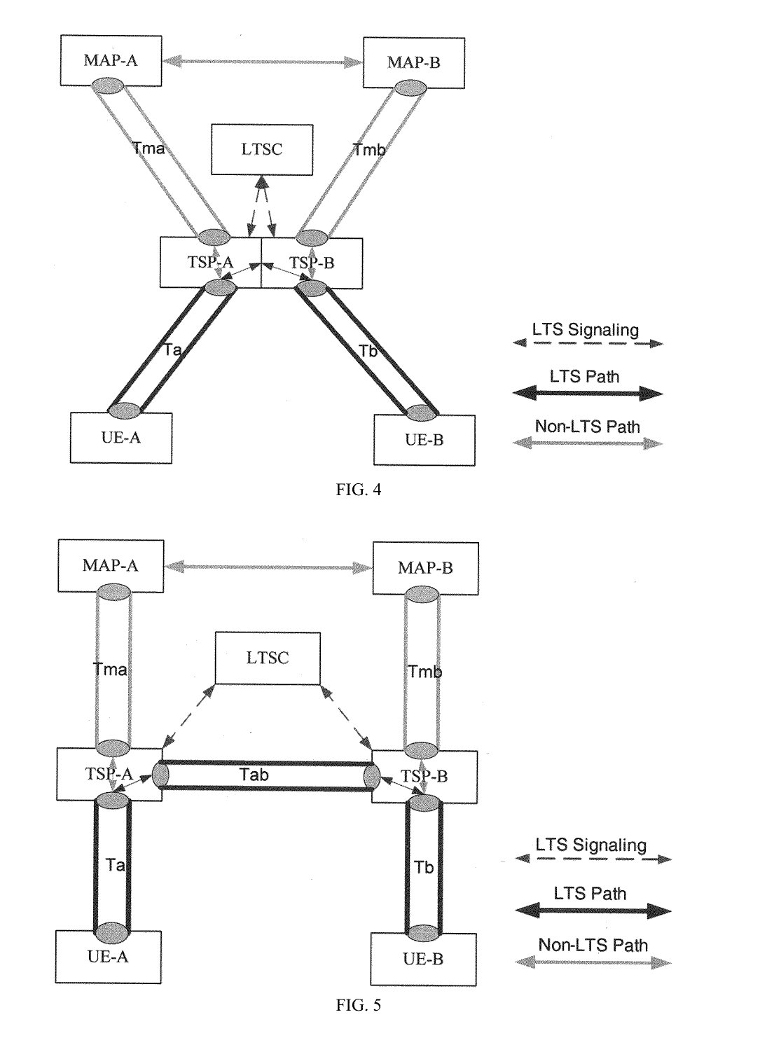

FIG. 4 shows an IP packet forwarding when TSP-A and TSP-B are located in the same network element.

After LTS path establishment, the TSP can maintain the mapping data between the UE tunnel and LTS path, e.g. for the LTS in the same TSP, the TSP-A(B) can maintain the following table:

| UE Tunnel | MA Tunnel | Dest IP | LTS status | LTS Path |
|---|---|---|---|---|
| Ta | Tma | 10.11.2.31 | Active | Tb |
| Ta | Tma | 10.11.9.8 | Inactive | Null |
| Ta | Tma | 0.0.0.0 | Unknown | Unknown |
| Tb | Tmb | 10.11.1.9 | Active | Ta |
| Tb | Tmb | 10.11.9.8 | Inactive | Null |
| Tb | Tmb | 0.0.0.0 | Unknown | Null |

FIG. 5 shows an IP packet forwarding when TSP-A and TSP-B are located in different network elements.

After LTS path establishment, TSP-A can maintain the following table:

| UE Tunnel | MA Tunnel | Dest IP | LTS status | LTS Path |
|---|---|---|---|---|
| Ta | Tma | 10.11.2.31 | Active | Tab |
| Ta | Tma | 10.11.9.8 | Inactive | Null |
| Ta | Tma | 0.0.0.0 | Unknown | Null |

While TSP-B can maintain the following table:

| UE Tunnel | MA Tunnel | Dest IP | LTS status | LTS Path |
|---|---|---|---|---|
| Tb | Tmb | 10.11.1.9 | Active | Tab |
| Tb | Tmb | 10.11.9.8 | Inactive | Null |
| Tb | Tmb | 0.0.0.0 | Unknown | Null |

Upon receiving an uplink IP data packet from the UE tunnel, the TSP can check the LTS status of the UE tunnel. There are for example three status types: active, inactive, unknown. If it is active, the TSP can forward the IP packet to the LTS path, and reset the expired timer of the destination IP. If it is inactive, the TSP can forward it to the MA tunnel, and reset the expired timer of the destination IP. If status is unknown, the TSP can perform a LTS decision. The TSP can create a record on the destination IP address to the table, which indicates LTS status as inactive. The record can be updated after the LTS decision.

Upon receiving a downlink IP data packet from the LTS path, the TSP can check the table and find the UE tunnel and forward it to the UE tunnel.

The O-TSP can be responsible for monitoring of the usage of the LTS path. If there is no IP data packet to a destination IP is received within a predetermined flow, a timer of the LTS path for the destination IP expires.

The LTS path can be updated when a terminal or UE moves, which includes:

the LTS path is established after handover, or

the LTS path terminates after handover, or

the LTS path remains unchanged after handover; e.g. eNodeB handover in the same SGW, the LTS path is performed in SGW, or

the LTS path is changed after handover.

The LTS paths can be for special traffic flows. In case that a handover happens to a UE, some of the traffic flows in the UE can be established after handover, and other traffic flows in the UE can be terminated after handover.

In an example or procedure for a handover in case of LTS, there are two TSPs in UE-A side, TSP-A1 and TSP-A2. The handover is performed e.g. from source TSP-A1 to target TSP-A1.

During handover of UE-A, this includes the following six data traffic flows:

| Traffic | Before | After | Impact of |
|---|---|---|---|
| Flow | handover | handover | LTS path |
| Traffic 1 | Non LTS | LTS via target | LTS path |
| | | TSP-A1 | established |
| Traffic 2 | LTS via source | Non LTS | LTS path |
| | TSP-A1 | | terminated |
| Traffic 3 | LTS via source | LTS via target | LTS path |
| | TSP-A1 | TSP-A1 | changed |
| Traffic 4 | LTS via source | LTS via TSP-A2 | LTS path |
| | TSP-A1 | | changed |
| Traffic 5 | LTS via TSP-A2 | LTS via target | LTS path |
| | | TSP-A1 | changed |
| Traffic 6 | LTS via TSP-A2 | LTS via TSP-A2 | LTS path |
| | | | unchanged |

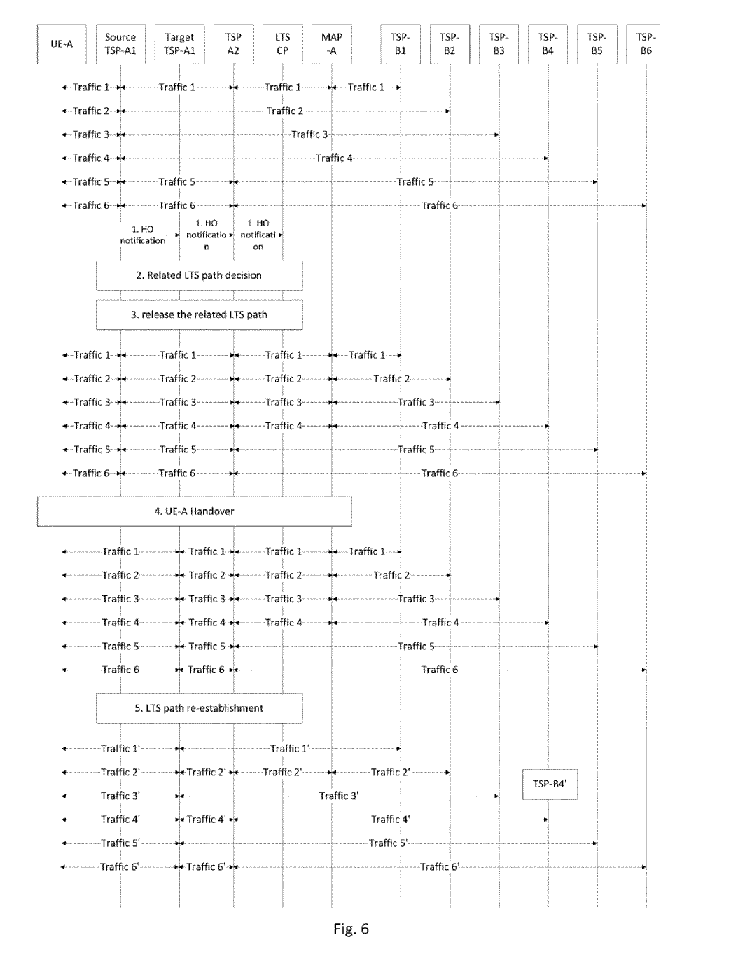

FIG. 6 shows an example handover procedure. In this example, a remote TSP is not used as an anchor point during handover, but the related LTS paths are released during handover, and the LTS paths are re-established after handover.

The procedure includes the following steps:

Step 1: Handover notification

The handover notification is sent to TSP and LTSCP for LTS handover decision; it includes the information of source TSP-A1 and target TSP-A2.

Step 2: Related LTS path decision

The LTSCP interacts with the TSPs to find the related LTS path for the handover. The related LTS path can be decided.

If the TSP in the LTS path is changed during handover, the LTS path is the related LTS path for the handover.

As the source TSP has the LTS path information, the related LTS path decision can be performed in the source TSP.

Step 3: Related LTS path release

To ensure a traffic continuity during handover, the related LTS path is not used during handover. The traffic in the related LTS path can be shifted to MAP-A via TSP-A2.

The source TSP can release the related LTS path, and forward the IP packet received to MAP-A via TSP-A2.

The IP packet forwarding path updating from LTS path to TSP-A2, can be performed after receiving the LTS path release confirmation, or in parallel with the related LTS path release procedure.

In case that the LTS path release confirmation is received, the LTS path is released and the non-LTS path on UE-B side is ready, and the QoS can be ensured during handover. In parallel with the related LTS path release procedure, this can reduce the delay of handover procedure.

In this example, if the LTS path for traffic flow 2, 3, 4 are released, the traffic flow 2, 3, 4 will can be routed to the MAP-A via TSP-A2.

Step 4: UE-A handover

A handover from TSP-A1 to TSP-A2 can be performed. A common handover procedure according to 3GPP specification can be used.

After handover, all the traffic to source TSP-A1 can be shifted to target TSP-A1.

The mapping of the IP address of the end device and the network entities serving the end device can be updated in the LTSCP. E.g. before UE-A handover, LTSCP maintains the following mapping:

| UE IP address | TSP |
|---|---|
| UE-A (10.11.1.9) | Source TSP-A1, TSP-A2 |

After UE-A handover, LTSCP can maintain the following mapping:

| UE IP address | TSP |
|---|---|
| UE-A (10.11.1.9) | Target TSP-A1, TSP-A2 |

Step 5: LTS path re-establishment

After handover, a LTS decision can be performed between the LTSCSP and target TSP-A1, TSP-A2 based on the updated information in LTSCP. The LTS decision can be performed with a similar procedure as described above.

After LTS decision, the LTS path can be re-established. The LTS path re-establishment can use a similar procedure as the LTS path establishment described above.

In this example, the following LTS paths can be re-established:

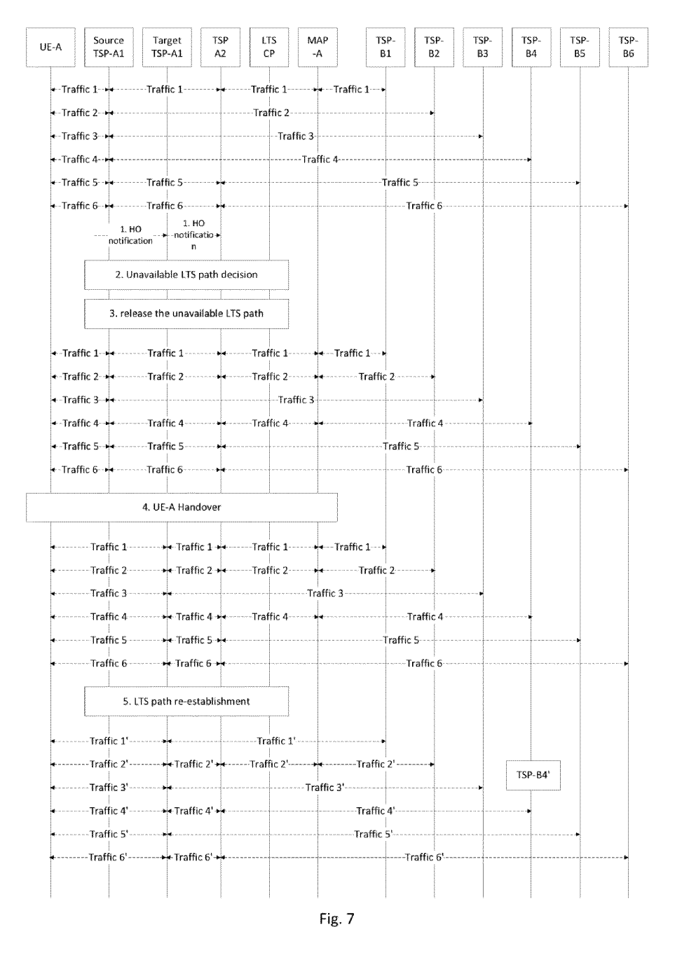

Traffic 1: the LTS path can be established via target TSP-A1.
Traffic 3: the LTS path can be established via target TSP-A1.
Traffic 4: the LTS path can be established via TSP-A2.
Traffic 5: the LTS path can be changed from TSP-A2 to target TSP-A1.
FIG. 7 shows another example for a handover procedure. In this example, the remote TSP is used as an anchor point during handover, only the unavailable LTS paths are released, the other related LTS paths are kept during handover, and the LTS paths are re-established after handover.

FIG. 7 shows the following steps:

Step 1: A handover notification being the same as in the example of FIG. 6

Step 2: Unavailable LTS path decision

The LTSCP interacts with the TSPs to find the related LTS path which is not available after handover based on the network topology of source TSP and target TSP.

In this example, traffic flow 2, 3, 4 are related LTS path, however, traffic 3 is still available after handover, traffic 2, 4 are the unavailable LTS paths.

Step 3: Unavailable LTS path release

The traffic in the unavailable LTS path can be shifted to MAP-A via TSP-A2.

Source TSP can release the related LTS path, and can forward the IP packet received to MAP-A via TSP-A2.

In this example, the LTS path for traffic flow 2, 4 are released and the traffic flow 2, 4 can be routed to the MAP-A via TSP-A2.

Step 4: UE-A handover

A handover from TSP-A1 to TSP-A2 can be performed. The common handover procedure in current 3GPP specification can be used.

After handover, all the traffic to source TSP-A1 is shifted to target TSP-A1.

Step 5: LTS path re-establishment

After handover, a LTS decision is performed between the LTCSP and target TSP-A1, TSP-A2. The LTS decision can use the similar procedure as described above.

After LTS decision, the LTS path can be re-established. The LTS path re-establishment can use the similar procedure as the LTS path establishment described above.

In this example, the following LTS paths are re-established:

Traffic 1: the LTS path is established via target TSP-A1.
Traffic 4: the LTS path is established via TSP-A2.
Traffic 5: the LTS path is changed from TSP-A2 to target TSP-A1.

Compared to the current EPS architecture, the method according to the first aspect of the present invention offers the following enhanced functions.

1) PCC: PCC can perform the following enhanced functions:
Sending the LTS policy to the MAP. In case of PMIP S5/S8 interface is used, the LTS policy is sent to TSP directly.

The LTS enhanced PCC function is optional. If there is no LTS policy sent from PCC, the static policy preconfigured in MAP and TSP can be used.

2) MAP: MAP can perform the following enhanced functions:
Sending the LTS policy to the TSP. In case of PMIP S5/S8 interface is used, the LTS policy is sent to TSP directly.
Bearer binding based on the LTS policy if the bearer binding function is located in MAP.
MA tunnel modification upon the request from TSP.
3) TSP: TSP can perform the following enhanced functions:
Bearer binding based on the LTS policy if the bearer binding function is located in TSP.
Sending the LTS policy between the TSPs.
Sending the traffic flow identifier to the LTSCP for the local traffic decision.
Interaction between TSPs for TSP selection in case of a distributed controller.
Interaction with LTSCP for TSP selection in case of a centralized controller.
LTS path establishment/modification/release between TSP-A and TSP-B.
MA tunnel modification during LTS path establishment.
Uplink and downlink IP packet forwarding.
Related LTS path checking in case of handover.
4) LTSCP: LTSCP is an additional functionality provided by the present invention and can perform the following functions:
A local traffic decision based on the traffic flow identifier received from TSP and
A TSP selection in case of a centralized controller.

L1 reference point: The following information is transferred in the L1 reference point from PCC to MAP:
1) Traffic flow identifier, a unique identifier which correlates the traffic flows sent to both UE-A and UE-B sides, e.g. unique session ID in IMS, TFT.
2) LTS policy: LTS allowed or not.

L2 reference point: The following information is transferred in the L2 reference point between MAP and TSP:
1) LTS policy from MAP to TSP
   Traffic flow identifier, a unique identifier which correlates the traffic flows sent to both UE-A and UE-B sides, e.g. unique session ID in IMS, TFT.
   LTS policy: LTS allowed or not.
1) MA tunnel modification from TSP to MAP
   QoS parameters

L3 reference point: the following information is transferred in the L3 reference point between TSP to LTSCP:
1) Traffic flow identifier from TSP to LTSCP
2) Local traffic indication from LTSCP to TSP
3) TSP selection from LTSCP to TSP in case of centralized controller.

L4 reference point: The following information is transferred in the L4 reference point between TSPs which serve the same UE (between up-TSP and down-TSP):
1) LTS policy from up-TSP to down-TSP
   Traffic flow identifier, a unique identifier which correlates the traffic flows sent to both UE-A and UE-B sides, e.g. unique session ID in IMS, TFT.
   LTS policy: LTS allowed or not:
2) MA tunnel modification from down-TSP to u-TSP
   QoS parameters
3) TSP selection notification from down-TSP to up-TSP in case of a distributed controller.

L5 reference point: The following information is transferred in the L5 reference point between TSPs serve the different UEs:
1) LTS path establishment/modification/release.

### List of Abbreviations

Abbreviation Full spelling

AGW Access Gateway

AS Application Server

DSMIP Dual Stack Mobile IP

EPC Evolved Packet Core

ePDG enhanced Packet Data Gateway

EPS Enhanced Packet System

FA CoA Foreign Agent Care Of Address

GW Gateway

Abbreviation Full spelling

HA Home Agent

HSS Home Subscriber Server

IP Internet Protocol

LMA Local Mobility Anchor

LTE Long Term Evolution

LTS Local Traffic Shortcut

LTSCP Local Traffic Shortcut Control Point

MA Mobility Anchor

MAG Mobile Access Gateway

MAP Mobile Anchor Point

MIP Mobile IP

MME Mobile Management Entity

O-TSP Originating Traffic Shortcut Point

PCC Policy and Charging Control

PCRF Policy and Charing Rule Function

PDN Packet Data Network

PGW PDN Gateway

PMIP Proxy Mobile IP

SAE System Architecture Evolution

SGW Serving Gateway

TFT Traffic Flow Template

TSP Traffic Shortcut Point

T-TSP Terminating Traffic Shortcut Point

UE User Equipment

What is claimed is:

1. A method for providing a local traffic shortcut (LTS) in a packet oriented mobile communication network, the method comprising:
storing in a local traffic shortcut control point (LTSCP) an IP address of a device served by a network node of the packet oriented mobile communication network along with a node-ID of the network node;
receiving an IP data packet by the network node from a served device and extracting a destination IP-address from the received data packet;
querying the LTSCP by the network node with the destination IP-address from the received data packet to identify existence and an identity of the network node for performing the LTS;
establishing an LTS path with the network node using the identity of the network node;
and
routing IP data packets having the destination IP-address through the LTS path.

2. The method according to claim 1, further comprising:
providing a LTS permission, indicating whether an establishment of the LTS path is admissible for the served device, to the network node when the served device connects to the network node, and
storing the LTS permission in the network node, wherein the network node interacts with the LTSCP only if the LTS permission is provided.

3. The method according to claim 1, further comprising:
extracting the destination IP-address of an IP data flow from a header of a first IP-data packet of said IP data flow to query said LTSCP for determining existence and identity of the network node to establish the LTS path.

4. The method according to claim 1, further comprising:
receiving, by the querying network node, the identity of the network node for performing the LTS only if the performing the LTS complies with configuration data of the LTSCP.

5. The method according to claim 1,
wherein the packet-oriented mobile communication network is a hierarchical network having hierarchy levels, and wherein the LTS path is established between network nodes of a same hierarchy level.

6. The method according to claim 5,
wherein, if a direct connection between a network node and another network node is available, the LTS path is established at a lowest possible hierarchy level of the packet oriented mobile communication network.

7. The method according to claim 1,
wherein a LTS database is provided at the LTSCP, and the method further comprises:
receiving, by the LTS database, the extracted destination IP-address of the received IP data packet from the network node for performing the query in said LTS database.

8. The method according to claim 1,
wherein the network node serving the devices includes a traffic shortcut point (TSP) comprising one of the group consisting of:
a base station,
a serving gateway, and
an enhanced packet data gateway (ePDG) of the packet oriented mobile communication network.

9. The method according to claim 1,
wherein the served device is a user equipment (UE) device comprising a mobile device connected with a base station via a wireless link.

10. The method according to claim 1, further comprising:
storing the established LTS path in a local memory of the serving network node having received the IP data packet from the served device, and
removing the established LTS path in the local memory after no IP packets are transferred along the LTS path for a configurable duration.

11. The method according to claim 10, further comprising:
updating the established LTS path stored in the local memory of the serving network node after performing a handover of the served device to another base station.

12. A packet-oriented network communication network comprising:
a local traffic shortcut Control Point (LTS CP) performing a query in a LTS database based on an extracted destination IP-address of a data packet received by a first network node from a served device to identify a second network node for establishment of an LTS path between the first network node and the second network node.
wherein the LTS database of the LTSCP is configured to store IP-addresses of devices served by the second network node of the packet oriented mobile communication network along with a node-ID of the second network node.

13. The packet-oriented network communication network according to claim 12, wherein the second network node includes a traffic shortcut point (TSP) comprising one of the group consisting of:
a base station,
a serving gateway (SGW), and
an enhanced packet data gateway (ePDG) of the packet oriented mobile communication network.

14. The packet-oriented network communication network according to claim 12,
wherein the served device is a user equipment (UE) device, the UE being a mobile device connected to a base station via a wireless link.

15. The packet-oriented network communication network according to claim 12,
wherein said packet-oriented mobile communication network comprises one of the group consisting of: a 3GPP network and a WIMAX network.
